(19) United States
(12) Patent Application Publication
(10) Pub. No.: US 2019/0060918 A1
(43) Pub. Date: Feb. 28, 2019

(54) CYCLONE SYSTEM

(71) Applicant: Hans-Joachim BOLTERSDORF, Brohl-Luetzing (DE)

(72) Inventor: Hans-Joachim BOLTERSDORF, Brohl-Luetzing (DE)

(21) Appl. No.: 15/773,622

(22) PCT Filed: Nov. 7, 2016
(86) PCT No.: PCT/DE2016/000388

§ 371 Date: May 4, 2018

(30) Foreign Application Priority Data
Nov. 6, 2015 (DE) 10 2015 014 285.2
Jun. 22, 2016 (DE) 10 2016 007 548.1

(51) Int. Cl. B04C 5/081; B04C 5/04; B04C 5/15; B04C 5/18; B04C 5/26

(52) U.S. Cl. CPC B04C 5/081; B04C 5/04; B04C 2009/008; B04C 5/18; B04C 5/26; B04C 5/15

(57) ABSTRACT

The invention relates to a cyclone system, in particular for a preparation device, comprising a top region that includes an off-center, preferably tangential, feed line and a central withdrawal line. The invention also relates to a method for operating a cyclone. The cyclone system has a flared outlet cone that flares at an angle of more than 0° and less than 20° relative to a central axis of the cyclone.

The invention relates to a cyclone system. In general, the invention relates to a rotary separator.

Such systems are known from PCTIDE2015/000405, to which full reference shall be made. In particular, the invention relates to a cyclone as it is described there.

Prior to treating the particles in the cyclone, it is favourable to treat them in a conditioner. Thereby, above all, particles containing liquid are relevant, which are defibrated in the conditioner. The conditioner is then used to blend particles and the friction of the particles against each other causes defibration. The effectiveness of the conditioner and, in particular, the energy consumption necessary for the defibration is highly dependent on the design of the conditioner.

The particles rinsed out in the underflow of a conditioner can be further processed in a preferably single-stage or multi-stage hydrocyclone in order to eliminate sand-like particles in particular. Such a hydrocyclone is simple with regard to its construction, leads to a high degree of efficiency and requires little energy. Depending on the usage of chemicals, aluminium particles can also be removed in such a hydrocyclone. Fibres that accumulate in the cyclone can either be removed in a disc filter or a thickener or led back to the upper course of the conditioner.

After completion of such a separation process, a multi-level purification process can follow, which begins with a highly enriched level of purifying water and ends with almost fresh water.

In order to be able to separate the mixture easier in the conditioner and/or in the cyclone, it is recommended to separate fractions of the mixture in a liquid that is lighter or heavier than water. This can be achieved, for example, by adding salt or alcohol to the water. However, hydrophobic liquids such as oils, for example, can also be used.

Materials with a density greater than 1 are generally separated in the hydrocyclone. However, that can be influenced by specific flow conditions. For this purpose, a liquid, such as water, can be added at the lower end of the hydrocyclone in a tapered collection cone or a discharge cone in order to create a counterflow. Preferably, the fluid is added via nozzles or inflow openings. These can be distributed around the circumference, arranged at one or a plurality of levels. The intake flow should be measured in such a way that a laminar flow promotes separation.

It is especially favourable if the cyclone system is manufactured out of a plurality of cyclones connected to each other in series. Thereby, cyclones are preferably designed as cyclones, where an extending output cone adjoins the central outlet. Favourable further embodiments are the object of the subclaims.

According to the method, a mixture fraction is initially treated in a first cyclone and after that, in a second cyclone, wherein more liquid is added to the counterflow in the first cyclone than in the second cyclone in order to increase selectivity. Thereby, an increased selectivity can be achieved by means of adding a lot of fluid to the counterflow, while the amount of added fluid can be reduced in the subsequent cyclone or in the subsequent cyclones.

A regulation makes it possible for material to be continuously taken from at least the first cyclone at the output cone, preferably as a pasty material. In addition, a discharge valve is only opened wide enough so that a sediment of discharge material remains in the cyclone and the discharge is continuously carried out according to the input at hand. For this purpose, sensors can detect the level of sediment in the discharge in order to control the opening of the valve via a control device.

An exemplary embodiment is shown in the drawing. In the figures:

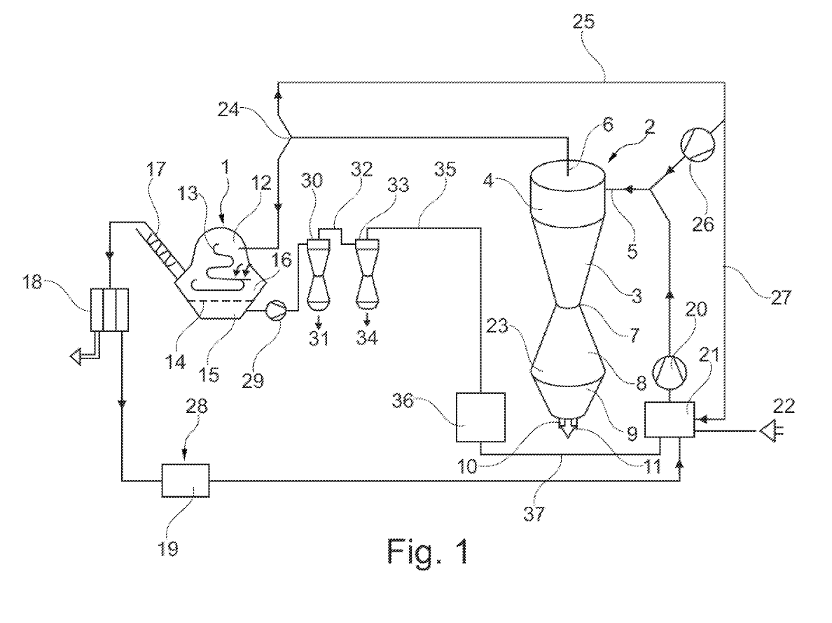

FIG. 1 schematically, an apparatus to treat composite materials with two small and one large hydrocyclone,

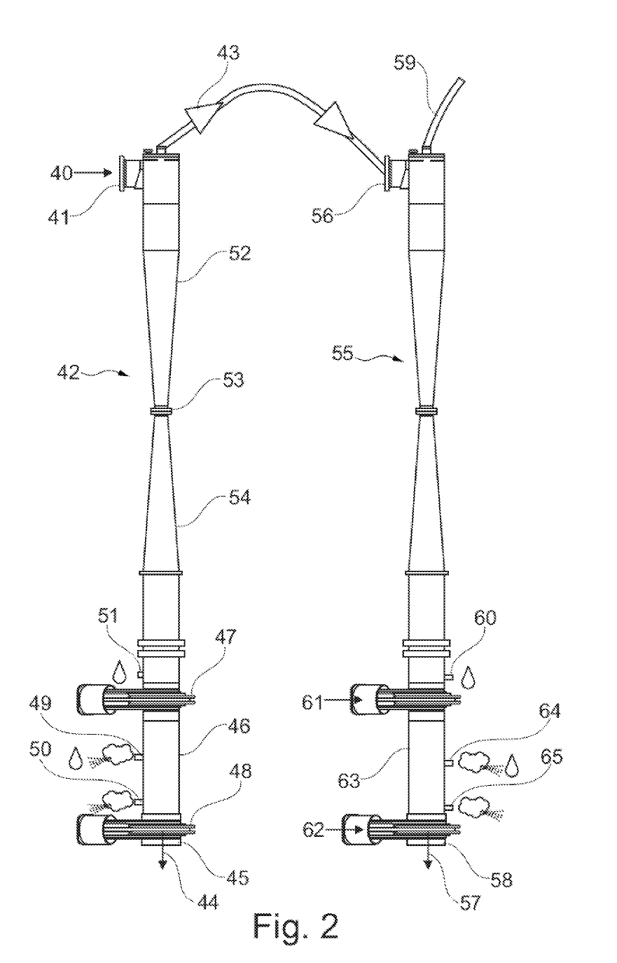

FIG. 2 two enlarged views of two cyclones connected to each other in series

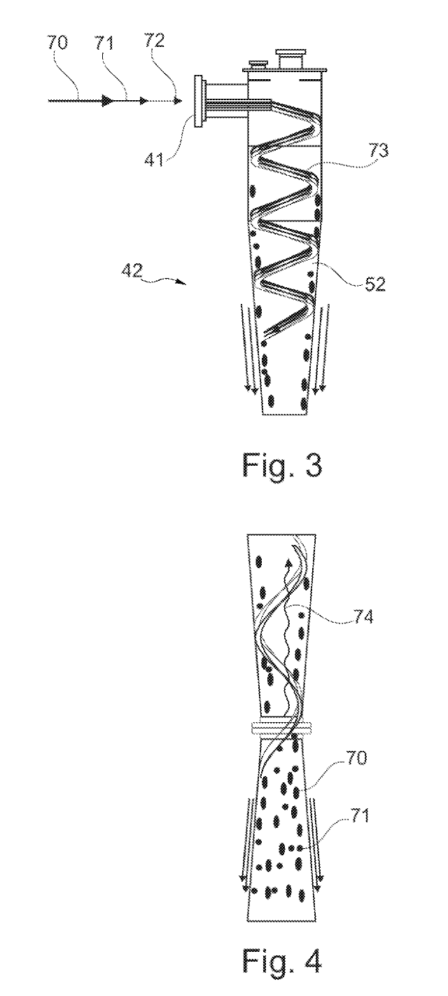

FIG. 3 the head area of the first cyclone from FIG. 2,

FIG. 4 the narrowed area of the first cyclone from FIG. 2,

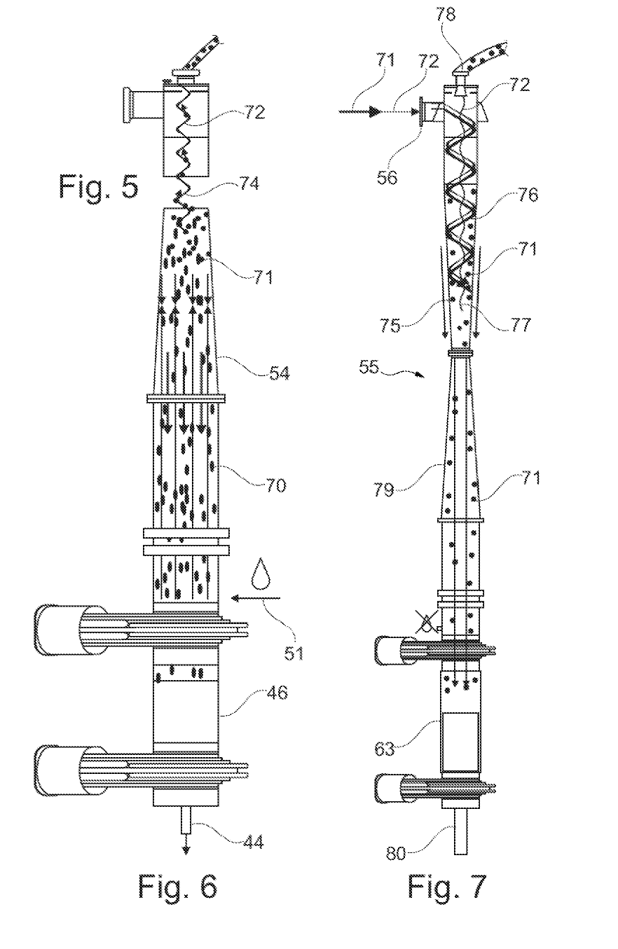

FIG. 5 the upper outlet of the first cyclone from FIG. 2

FIG. 6 the lower are of the cyclone shown in FIG. 2,

FIG. 7 the second cyclone shown in FIG. 2,

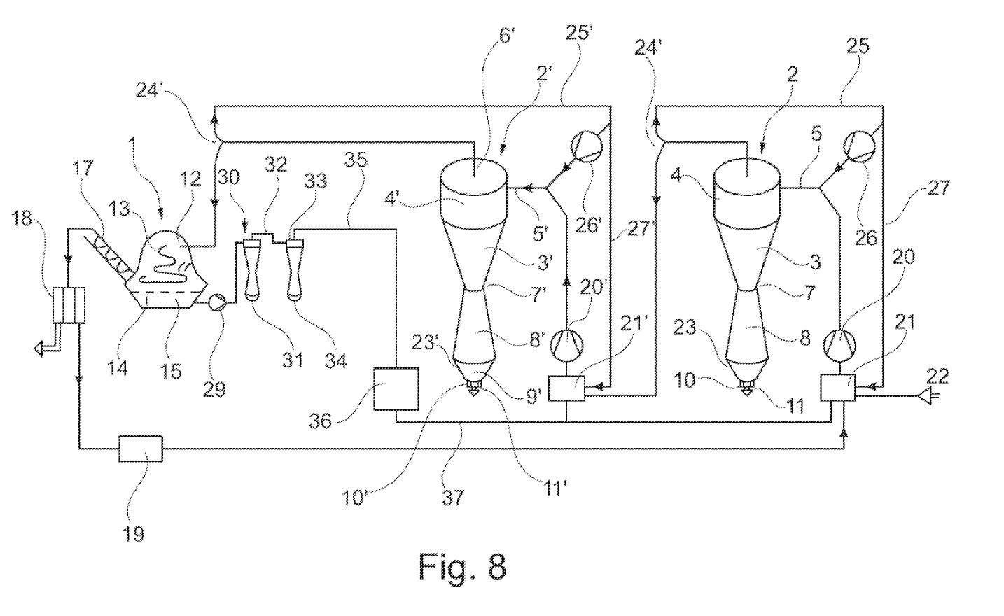

FIG. 8 schematically, an apparatus to treat composite materials with two small and two large hydrocyclones, and

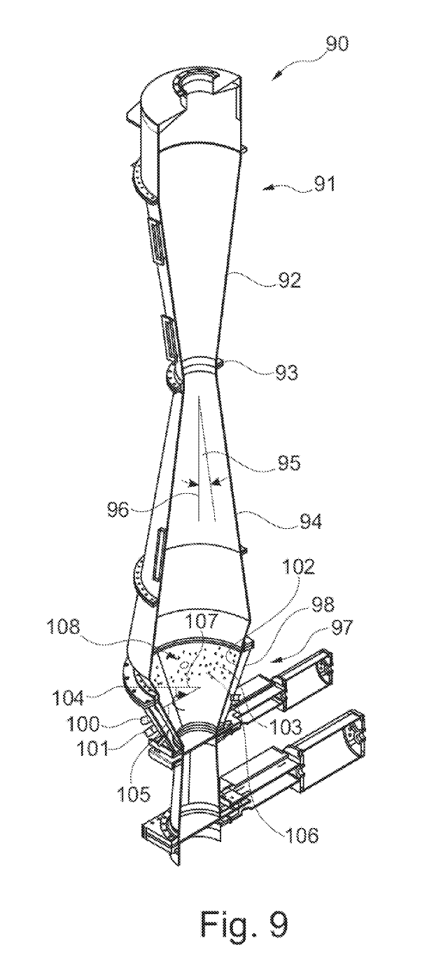

FIG. 9 a cyclone with a double-walled output cone in a cut-out view.

FIG. 1 shows the integration of a conditioner 1 in an apparatus with a large hydrocyclone 2. This hydrocyclone 2 has an input cone 3 and a head area 4. In the head area, a tangential inlet feed 5 and a central outlet 6 are provided. The input cone 3 can extend up to the head area 4 so that the head area is also designed in a conical manner. In an alternative embodiment, the input cone 3 can also be cylindrical.

A smaller diameter 7 can be found at the lower end of the input cone 3, which leads from the input cone 3 into an expanding output cone 8 like a constricting element. On the lower end of the output cone 8, a collection cone 9, which is tapered again, is provided, which has an discharge opening 11 leading through a sluice 10.

The conditioner 1 has as screw 13 in its upper area 12 and a strainer 14 underneath, which separates the upper area 12 from an underflow 15. The screw 13 is preferably shaped like a spiral, which only slides over the strainer 14 via the screen plate, thereby discharging the material outside in a radial manner. A screw leading to the spiral is preferably done without to avoid the entry of air into the lower area of the conditioner and to facilitate the discharge of air in the conditioner.

The material mixture 16 treated in the conditioner 1 is discharged by means of a discharge screw conveyor 17 and conveyed to a buffer 18, which can hold a large amount of the material mixture in order to feed it to a collector 19 if required, from where the material is conveyed to the decentralized inlet feed 5 of the hydrocyclone 2 via a centrifugal pump 20. The collector 21 serves to dilute the material in the circuit with water 22 and then feed it to the centrifugal pump 20 in a liquefied state. The collector 21 can be designed as a screw conveyor, to which liquid is added in order to achieved a consistency that can be conveyed via the centrifugal pump 20.

Instead of a discharge coil or a discharge screw conveyor 17 and buffer 19, a particularly large discharge coil can be provided, which, on the one hand, makes it possible to take material from the upper course of the conditioner 1 and, on the other hand, to store as much material as possible, which can then gradually be liquefied and added to the centrifugal pump 20.

In the hydrocyclone 2, the material initially moves through the spiral up to the constriction 7 and from there, it goes into the output cone 8, where a material fraction is taken via the sluice 10. The other material moves through the spiral within the output cone 8 and then goes up into the input cone 3 again and back to the conditioner 1 via the central outlet 6.

Supply openings 23 in the lower area 8 of the cyclone 2 make it possible to supply water or another liquid in order to facilitate the separation of the material in the cyclone through a flow component radially aligned from the outside inwards. For this purpose, the supply openings can be designed as nozzles, which allow for a liquid to enter into the cyclone in a defined flow direction.

At the crossover 24, the main flow enters into the line 25 in an arced manner and from there to the centrifugal pump 26. Thereby, this circulation pump 26 conveys from the central outlet 6 of the cyclone 2 to the tangential inlet feed 5 of the cyclone 2.

A bypass of 27, which not necessarily required, allows a partial flow to be drawn away prior to the circulation pump 20 and for it to be led back to the centrifugal pump 20, either directly or via the collector 21.

The circuit between the hydrocyclone 2, the conditioner 1 and the centrifugal pump 20 makes it possible to treat the mixture 16 for a longer period of time, and thereby, to take different fractions from the centrifugal pump at the discharge opening 11.

When all fractions of value have been taken, the sliding changeover 18 is switched and the light material, such as polyeofins in particular, for example, polyethylene and polypropylene, is discharged.

Thereby, various plastic materials can be separated already by selecting the fluid 22 in the hydrocyclone 2. As an alternative, after the changeover 18 in another cyclone, which contains a fluid that is lighter or heavier than water, the plastics can be separated.

New material 28 is added to the collector 21 as a substance mixture either prior to the centrifugal pump 20 or added at another point, such as at the buffer 19 for example.

The underflow 15 of the conditioner 1 is added to a small cyclone 30 via a pump 29, where sand or also aluminium 31, for example, is separated and discharged while a coarse-grain-purified suspension 32 is lead to a second cyclone 33, in which fine grain 34 sinks and is discharged while purified fibre material 35 is discharged via the upper course and fed to a filter 36. Here, the fibre materials are separated while the liquid goes to the collector 21 via the line 37 and from there, it reaches to the centrifugal pump 20.

FIG. 8 shows the use of two large cyclones connected in series. Thereby, a smaller cyclone has a maximum diameter of less than 0.5 m and an inlet feed diameter of less than 100 mm while a large cyclone has a maximum diameter of more than 0.7 m and a diameter of more than 150 mm at the inlet feed. The arrangement corresponds to that which is described in FIG. 1 and a cyclone 2 is run through first and then, a cyclone 2′ is run through.

The principle of one of the small cyclones and the interaction of the two small cyclones is described in the following based on the example shown in FIGS. 2 to 7.

While a good separation of different materials can already be achieved with a single cyclone of the ones shown in FIG. 2, the combination of such cyclones offers the possibility of fractionation. Thereby, preferably, two or more cyclones are connected to each other in series. The material to be treated 40 enters into the first cyclone 42 via the tangential inlet feed 41. In it, the material separates into a coarse-grain-purified suspension 43 and coarse grain 44, which can be removed from the first cyclone 42 via the outlet 45.

In order to remove the coarse grain, on the lower end of the cyclone 42, there is a collection container 46, which is respectively limited at the top and bottom by a slider 47 and 48. The openings 49 and 50 in the collection container 46 are used to supply and drain filling water, and for ventilation.

An opening 51 above the slider 47 and in the lower area of the cyclone 42 is used to supply the cyclone 42 with counter-flowing water in the lower area of the cyclone.

The cyclone 42 consists of an upper part 52, which is conical or cylindrical and a constriction 53, under which a conical cyclone element extends downwards.

The second cyclone 55 is downstream to the first cyclone 42 and the coarse-grain-purified suspension 43 on the upper course of the first cyclone 42 is supplied to the tangential inlet feed 56 of the second cyclone 55. The second cyclone 55 is constructed like the first cyclone 42 and it is used to separate the coarse grain 57 from the coarse-grain-purified suspension, which is removed from the second cyclone 55 at the outlet 58. On the upper course of the second cyclone 55, the coarse- and fine-grain-purified suspension 59 is removed from the second cyclone 55. Also at the second cyclone, counter-flowing water 60 supports the separation in the cyclone and sliders 61 and 62 delimit a collection container 63, on which openings 64 and 65 are provided for ventilation and for filling water.

FIG. 3 shows how coarse grain 70, fine grain 71 and fibre material 72 is supplied to the tangential inlet feed 41. This fibre-material suspension 70, 71, 72 contaminated with coarse grain and fine grain is tangentially conveyed into the first cyclone 42 by means of a pump 29. A downward-orientated vortex 73 forms in the cyclone 42, which is referred to as the primary vortex. This primary vortex initially pulls fibre material, coarse grain and fine grain downward. The particles with a higher specific weight that the weight of the fluid include coarse grain 70 and fine grain 71 in the present example. These particles are pressed out of the primary vortex 73 due to a high centrifugal force and sink down on the edge of the cone 52.

Due to the conical shape 52 and the constriction 53, the vortex 73 is forced to reverse. A second upwards-orientated vortex forms, the secondary vortex 74, which travels along with the light particles upwards and is transported over the upper course into the second cyclone 55. Coarse grain 70 and fine grain 71 sink again in the lower part 54 of the first cyclone 42.

FIG. 5 shows that the sinking of the lighter fine grain 71 is prevented from sinking due to the counter-flowing water 51, which is supplied from below, and that it is initially held in suspension in the cone 54. The lighter fine grain 71 then enters into the upwards-flowing vortex 74 and is transported alone with the fibre material 72 into the second cyclone 55 via the upper coarse.

The heavier coarse grain 70 is not stopped by the counter-flowing water 51 and sinks down again. By means of this, a pure coarse grain fraction 44 results in the first cyclone 42, which can be removed in pasty form via the collection container 46.

Due to the amount of the counter-flowing water 51, thereby the result of the fractionation can be determined.

FIG. 7 shows the separation in the second cyclone 55, at the tangential inlet feed 56 of which, coarse-grain-purified fibre-material suspension consisting of fibre material 72 and fine grain 71 is supplied. Fibre material 72 and fine grain 71 form a primary vortex 76 in the upper part 75 of the second cyclone 55 and fine grain 71 is pressed out of the primary vortex 76 and sinks down on the edge of the cone 75. The purified fibre material 72 is discharged with the secondary vortex 77 via the upper course 78.

The fine grain 71 sinks down in the second cyclone 55 so that a fine-grain fraction results in the lower area 79 of the second cyclone 55, which can be removed as a pasty fine grain fraction 80 via the collection container 63. The longer the lower cone is 79, the finer grain to be separated can be when the centrifugal part is designed accordingly in the upper area 75. In the second cyclone 55, no counter-flowing water is generally used.

The upper part of the cyclone can have a cylindrical area or even completely be cylindrical up to the constriction. In addition, this cylindrical area as a pipe in the upper area of the cyclone could be shorter than the conical area under the constriction.

FIG. 9 shows a hydrocyclone 90, which can be used as a smaller or, in particular, also as a larger cyclone. In the upper area 91, the fluid to be treated tangentially enters into the cyclone and moves in a spiral on the conical wall 92, which can also be cylindrical in shape, up to a point 93, after which an output cone 94 adjoins. The small angle 95 of the wall 92 from 6 to 7° with relation to the centre axis 96 provides for a sufficient laminar flow in the output cone.

This is joined by a re-narrowing collection cone 97, which has a double-wall design. The outer wall 98 has two inlet feeds 100, 101 for water or gas and the inner wall 102 has an upper area 108 above the inlet feeds 100 and 101 with a plurality of supply openings 104. Since the supply openings are bores in the inner wall 103, which are bored perpendicularly into the wall, a supply flow 105 at a lift angle 106 of more than 0° and preferably less than 20° with relation to a normal 107 of the central axis 96 results. The bores of the supply openings 104 have a diameter of 2 to 6 mm and preferably of approximately 4 mm. The inlet feeds 100 and 101 lead to a flow, which strikes against the outer side of the inner wall 103 lying opposite and is distributed between the inner wall 103 and the outer wall 98. By means of this, an overpressure between the walls results, which, via to the supply openings 104, ensures that a consistent and evenly distributed current enters into the cyclone, which is slighted orientated upwards in order to give the particles in the cyclone an upwards impulse. By means of this, the effect is intensified that the lighter particles flow upwards while the heavier particles sink downwards.

1. Cyclone system, in particular for a conditioner (1) with a head area (4), which has a decentralized, preferably tangential inlet feed (5) and a central outlet (6), and an extending output cone (8) with a central axis (96), wherein the output cone (8) extends at an angle (95) of more than 0° and less than 20° in relation to the central axis (96).

2. Cyclone system according to claim 1, wherein the head area (4) is cylindrical up to an extending output cone (8).

3. Cyclone system according to claim 1, wherein a collection cone (9), which is tapered again, adjoins the output cone (8).

4. Cyclone system according to claim 1, wherein a lockable discharge opening (11) adjoins the output cone (8) or the collection cone (9).

5. Cyclone system according to claim 4, wherein the discharge opening (11) has a sluice (10).

6. Cyclone system according to claim 4, wherein the discharge opening (11) has a valve, which makes a continuously regulated discharge possible.

7. Cyclone system according to claim 1, wherein it has supply openings (104) for an inlet feed of a fluid or a gas, which are arranged in a wall (103) in such a way that a supply flow (105) at a lift angle (106) of more than 0° and preferably less than 20° with relation to a normal (107) of the central axis (96) results.

8. Cyclone system according to claim 1, wherein the wall (103) is double-walled in sections and has at least one inlet-feed opening (100, 101) on the outer wall (98) and a plurality of supply openings (104) on the inner wall (103)

9. Cyclone system according to claim 8, wherein at least one inlet-feed opening (100, 101) and preferably each inlet-feed opening are arranged within an area (108), in which the inner wall (103) does not have any supply opening (104) so that the inner wall (103) forms an impact surface for the medium fed through the inlet-feed opening (100, 101).

10. Cyclone system according to claim 1, wherein a plurality of cyclones (2, 2′) with a maximum diameter of more than 0.7 m and a tangential inlet feed (5) with a diameter of more than 150 mm are connected in series in order to increase the degree of purification.

11. Cyclone system according to claim 1, wherein the tangential inlet feed (5) is arranged in such a way that the flow within the cyclone is supported by means of Coriolis force.

12. Method to operate a cyclone, wherein the flow is set in such a way within the extending output cone (8) that the output cone (8) is fully filled with fluid during operation and in the outer area, a downwards-orientated rotary flow is present and a upwards-orientated flow is present in the central area.

13. Method according to claim 12, wherein the head area (4) is also fully filled with fluid during operation and in the outer area, a downwards-orientated rotary flow is present and a upwards-orientated flow is present in the central area.

14. Method according to claim 12, wherein a mixture fraction is initially treated in a first cyclone (2) and after that, in a second cyclone (2′), wherein more liquid is added to the counterflow in the first cyclone than in the second cyclone in order to increase the selectivity.

15. Method according to claim 14, wherein material is continuously taken from at least the first cyclone at the discharge opening (11), preferably as a pasty material.
